(19) United States
(12) Patent Application Publication
(10) Pub. No.: US 2022/0341342 A1
(43) Pub. Date: Oct. 27, 2022

(54) VARIABLE VANE APPARATUS

(71) Applicant: General Electric Company, Schenectady, NY (US)

(72) Inventors: Matthew Nauss, Cincinnati, OH (US); Eric Alan Ford, Fort Thomas, KY (US); Hans R. Wagner, Liberty Township, OH (US)

(21) Appl. No.: 17/236,105

(22) Filed: Apr. 21, 2021

(51) Int. Cl. F01D 17/16; F02C 9/22; F01D 9/04

(52) U.S. Cl. CPC F01D 17/162; F02C 9/22; F01D 9/041; F02K 3/06

(57) ABSTRACT

A variable vane apparatus includes: a case including two or more spaced-apart case pivots; a bellcrank pivotally connected to each case pivot, each of the bellcranks having an input arm and an output arm; a master rod including two or more segments pivotally connected to each other at rod pivots; and wherein the input arm of each of the bellcranks is pivotally connected to one of the rod pivots.

### STATEMENT REGARDING FEDERALLY SPONSORED RESEARCH & DEVELOPMENT

This invention was made with United States Government support. The Government has certain rights in this invention.

### BACKGROUND OF THE INVENTION

This invention relates generally gas turbine engines and, more particularly, to a method and apparatus for actuating variable hardware of such engines.

A gas turbine engine includes a compressor used to pressurize intake air which then flows to a downstream combustor and one or more turbines. A typical compressor includes a series of stages, each stage including a row of stationary stator vanes and a row of rotating compressor blades.

In some gas turbine engines, one or more stages of the stator vanes are variably actuated—known as variable stator vanes (VSVs). VSVs are stationary or static (meaning non-rotating) airfoils. Each stage is provided with a ring array of multiple airfoils, for example 25-50 airfoils. The airfoils are “variable” in the sense that their inboard and outboard ends are pivoted, and they can be rotated about a generally radial axis to change their stagger angle. The reason for changing this angle would be to throttle the airflow through the engine and/or to optimize the airflow angle through the airfoils. This is helpful to allow the engine to operate efficiently in different operating conditions (e.g., low-speed operation versus high-power operation).

Typically, in the prior art, each VSV has a trunnion at its outboard end that passes through the stator case and is coupled to a lever. All of the levers for each stage of airfoils are usually connected to a unison ring that surrounds the engine case. The VSVs are retained to the stator case using a bushing assembly.

Rotating this ring clockwise or counterclockwise about the engine centerline axis would cause all of the connected VSVs to open or close in unison. The unison ring is ultimately operated by an actuator, e.g., hydraulic, pneumatic, or electric actuator. Various types of mechanical connections between the actuator and the unison ring are known.

### BRIEF DESCRIPTION OF THE INVENTION

According to one aspect of the technology described herein, a variable vane apparatus includes: a case including two or more spaced-apart case pivots; a bellcrank pivotally connected to each case pivot, each of the bellcranks having an input arm and an output arm; a master rod including two or more segments pivotally connected to each other at rod pivots; and wherein the input arm of each of the bellcranks is pivotally connected to one of the rod pivots.

According to another aspect of the technology described herein, a gas turbine engine includes: a turbomachinery core including a compressor, a combustor, and a turbine in serial flow relationship; the core including a case including two or more spaced-apart case pivots; a bellcrank pivotally connected to each case pivot, each of the bellcranks having an input arm and an output arm; a master rod including two or more segments pivotally connected to each other at rod pivots; and wherein the input arm of each of the bellcranks is pivotally connected to one of the rod pivots.

### BRIEF DESCRIPTION OF THE DRAWINGS

The invention may be best understood by reference to the following description taken in conjunction with the accompanying drawing figures in which:

FIG. 1 is a cross-sectional, schematic view of a gas turbine engine incorporating a variable vane apparatus;

FIG. 2 is a schematic, partially view of a single variable vane assembly of the engine of FIG. 1;

FIG. 3 is a schematic plan view of a portion of a gas turbine engine case incorporating a prior art variable vane apparatus;

FIG. 4 is a schematic plan view of a portion of a gas turbine engine case incorporating an exemplary variable vane apparatus according to an aspect of the present invention;

FIG. 5 is an enlarged view of a portion of FIG. 4;

FIG. 6 is a schematic plan view of a portion of a gas turbine engine case showing an alternative bellcrank;

FIG. 7 is a schematic plan view of a portion of a gas turbine engine case showing another alternative bellcrank; and

FIG. 8 is a schematic plan view of a portion of a gas turbine engine case showing another alternative bellcrank.

### DETAILED DESCRIPTION OF THE INVENTION

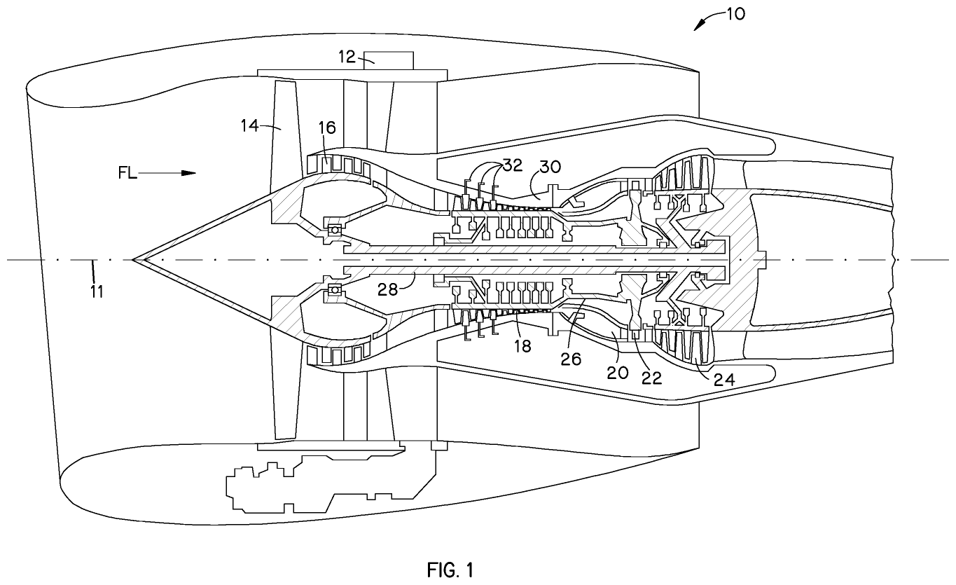

Referring to the drawings wherein identical reference numerals denote the same elements throughout the various views, FIG. 1 depicts an exemplary gas turbine engine 10. While the illustrated example is a high-bypass turbofan engine, the principles of the present invention are also applicable to other types of engines, such as low-bypass turbofans, turbojets, turboprops, unducted fan engines or open rotor engines, etc., as well as turbine engines having any number of compressor-turbine spools. Alternatively, the variable vane apparatus described herein could be incorporated in another type of turbomachinery such as a fan, pump, or compressor driven by an external prime mover. The engine 10 has a longitudinal center line or axis 11. Operation of the engine 10 may be controlled in whole or in part by an electronic engine controller shown schematically at 12. One example of such an electronic engine controller 12 is a full authority digital engine control (“FADEC”).

It is noted that, as used herein, the terms “axial” and “longitudinal” both refer to a direction parallel to the centerline axis 11, while “radial” refers to a direction perpendicular to the axial direction, and “tangential” or “circumferential” refers to a direction mutually perpendicular to the axial and radial directions. As used herein, the terms “forward” or “front” refer to a location relatively upstream in an air flow passing through or around a component, and the terms “aft” or “rear” refer to a location relatively downstream in an air flow passing through or around a component. The direction of this flow is shown by the arrow “FL” in FIG. 1. These directional terms are used merely for convenience in description and do not require a particular orientation of the structures described thereby.

The engine 10 has a fan 14, booster 16, high-pressure compressor or “HPC” 18, combustor 20, high pressure turbine or “HPT” 22, and low-pressure turbine or “LPT” 24, arranged in serial flow relationship. Collectively, the fan 14, booster 16, and LPT 24 define a low-pressure system or low-pressure spool of the engine. Collectively, the HPC 18, combustor 20, and HPT 22, define a high-pressure spool of the engine 10, also referred to as a “core” or “core engine”.

In operation, pressurized air exiting the HPC 18, is mixed with fuel in the combustor 20 and ignited, thereby generating combustion gases. Some work is extracted from these gases by the HPT 22 which drives the HPC 18 via an outer shaft 26. The combustion gases then flow into the LPT 24, which drives the fan 14 and booster 16 via an inner shaft 28. As used herein, the engine 10 is considered to be “operating” when fuel is being is supplied to and burned in the combustor 20, and the resulting combustion gases are driving rotation of at least the core.

The HPC 18 includes a number of stages of rotating blades and stationary vanes (stator vanes), all surrounded by a compressor case or case 30. The HPC 18 may incorporate a variable vane assembly, shown schematically at 32.

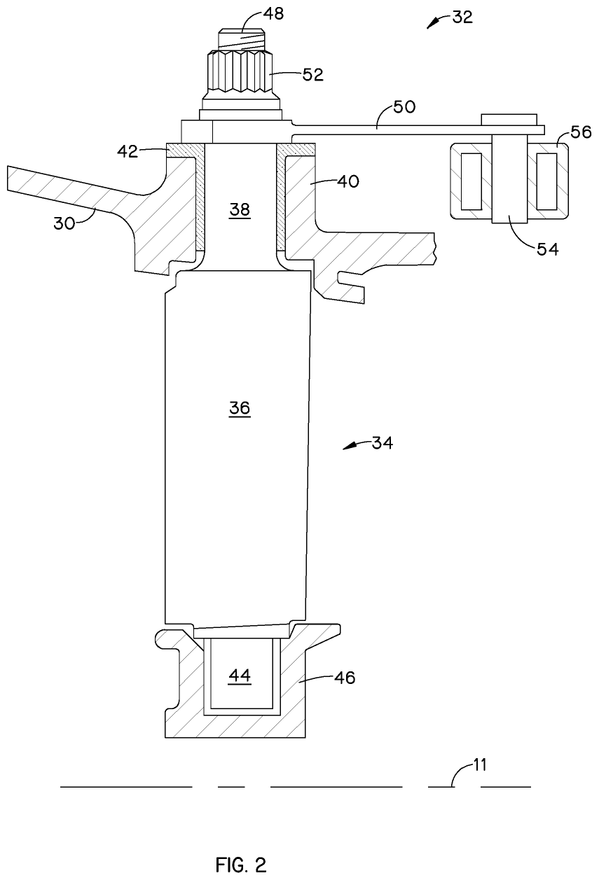

FIG. 2 shows a variable vane assembly 32 secured to a case such as compressor case 30. It will be understood that the variable vane assembly 32 could be incorporated as a variable stator vane in the HPC 18, or alternatively could be used to provide variable actuation of any other stationary airfoil in the engine 10. Examples of such variable airfoils include variable inlet vanes, variable outlet vanes, and variable turbine nozzles. The variable vane assembly 32 includes a plurality of circumferentially spaced apart variable stator vanes 34 arrayed around the centerline 11 (only one vane 34 shown). Each vane 34 includes a conventional airfoil 36 having a leading edge, a downstream trailing edge, and pressure and suction sides extending therebetween.

Each vane 34 further includes a radially outer trunnion 38 extending coaxially and integrally outwardly from the tip or outboard extent of the airfoil 36 for pivotally mounting the vane 34 in a corresponding mounting boss 40 formed in the case 30. A trunnion bushing 42 is disposed between the outer trunnion 38 and the mounting boss 40 to decrease the friction and wear therebetween. In the exemplary embodiment illustrated in FIG. 2, each vane 34 also includes a radially inner trunnion 44 mounted in a sealing ring 46, although other arrangements could be used.

An integrally formed mounting stem 48 extends radially outwardly from an outer distal end of the outer trunnion 38. The mounting stem 48 has a threaded portion and a seating portion formed thereon. A lever arm 50 is placed, at one end thereof, over the mounting stem 48 for engagement with the seating portion thereof. A nut 52 is threaded onto the threaded portion of the mounting stem 48 to secure the lever arm 50 thereto so that rotational movement of the lever arm 50 will be transferred to the vane 34. An actuation pin 54 is disposed at the other end of the lever arm 50 and is received in a complementary hole in an annular actuation or unison ring 56, which controls the position of the lever arm 50. It will be understood that the unison ring 56 extends around the exterior of the compressor case 30. The lever arms 50 of each of the vanes 34 are connected to the unison ring 56 so that the orientation of the vanes 34 can be adjusted in unison, by rotation of the unison ring 56 about the centerline 11.

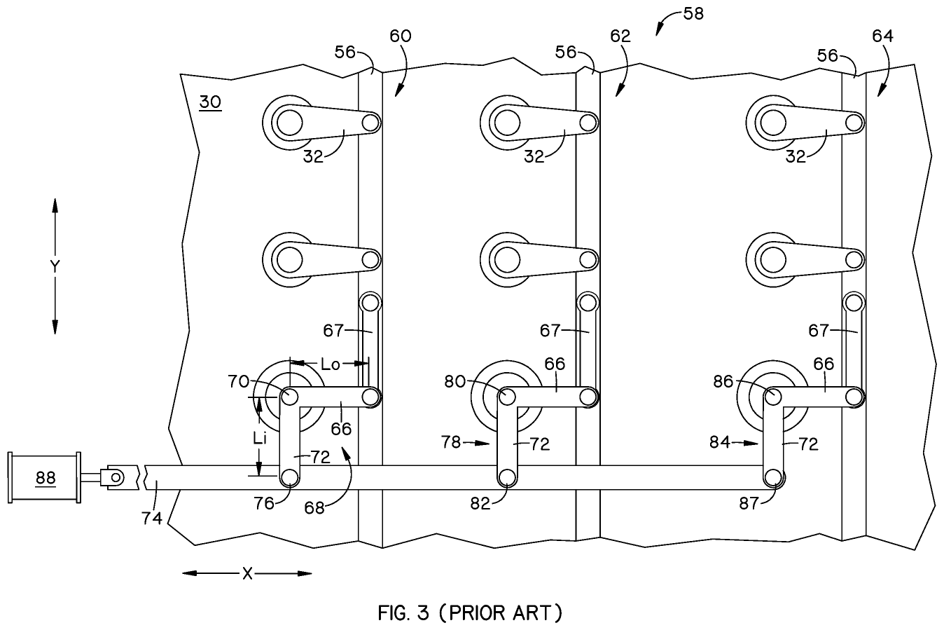

FIG. 3 illustrates a prior art variable vane apparatus 58 comprising several stator vane assemblies 32 mounted to a compressor case 30. The stator vane assemblies 32 are associated with different stages of the engine which are labeled first, second, and third stages 60, 62, and 64 respectively, not necessarily corresponding to any specific stages of the HPC 18. The unison ring 56 of the first stage 60 is pivotally connected to an output arm 66 of a first bellcrank 68 which is pivotally connected to the compressor case 30 at a first case pivot 70. The pivotal connection of any of the bellcranks to their respective unison rings may be indirect, for example through a link 67 as illustrated which has a first end pivotally connected to the output arm 66 and a second end pivotally connected to the unison ring 56. Such links 67 provide compliance so that the stator vane assemblies 32 and bellcranks can move without binding, even when the output arm 66 is a different length than the lever arms 50. An input arm 72 of the first bellcrank 68 is pivotally connected to a rigid master rod 74 at a first rod pivot 76.

The unison ring 56 of the second stage 62 is pivotally connected to an output arm 66 of a second bellcrank 78 which is pivotally connected to the compressor case 30 at a second case pivot 80. An input arm 72 of the second bellcrank 78 is pivotally connected to the master rod 74 at a second rod pivot 82.

Finally, the unison ring 56 of the third stage 64 is pivotally connected to an output arm 66 of a third bellcrank 84 which is pivotally connected to the compressor case 30 at a third case pivot 86. An input arm 72 of the third bellcrank 84 is pivotally connected to the master rod 74 at a third rod pivot 87.

The master rod 74 is connected to an actuator 88 (shown schematically) which is operable to selectively translate the master rod 74 in a direction labeled “X” which may be parallel to engine centerline 11 (FIG. 1). A power source (not shown) for operating the actuator 88 may be mechanical, hydraulic, pneumatic, or electrical. Control of the actuator 88 may be by conventional means such as the controller 12.

Translation of the master rod 74 causes rotation of the first, second, and third bellcranks 68, 78, and 84 about their respective case pivots 70, 80, and 86. This in turn causes the output arms 66 to move their respective unison rings 56 producing movement in a direction labeled “Y” which is generally perpendicular to direction X.

The ratio of displacement in direction Y to displacement in direction X (referred to herein as an “output ratio”) is governed by the relative length of the output arm 66 (labeled Lₒ) and the input arm 72 (labeled Lᵢ).

In general, for mechanical compatibility and avoidance of binding in the mechanism, each of the input arms 72 share a common length. Accordingly, if it is desired to vary the Y-direction displacement, this is carried out in the prior art solely by varying the length of the output arms 66. This can make it impracticable or impossible to implement certain output ratios. For example, if the ratio Lₒ/Lᵢ is to be less than unity, the pivot at the distal end of the output arm 66 must move closer to the corresponding case pivot. However, there is a limit to how short the output arm 66 may be, because if it is too short there will ultimately be mechanical interference between the pivoting hardware and/or the unison ring 56 and the case pivot.

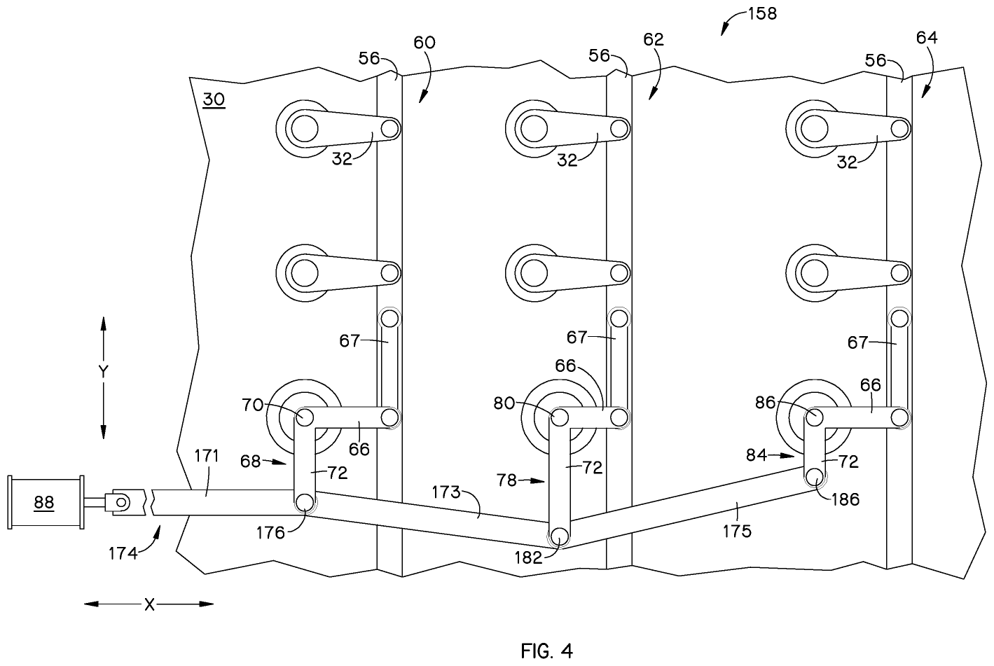

This arrangement may be improved upon by incorporating a segmented master rod. FIG. 4 illustrates an exemplary variable vane apparatus 158 comprising several stator vane assemblies 32 arranged in a compressor case 30. The stator vane assemblies 32 are associated with different stages of the engine which are labeled first, second, and third stages 60, 62, and 64 respectively, not necessarily corresponding to any specific stages of the HPC 18.

The complete variable vane apparatus 158 includes a master rod 174 comprising two or more segments which are pivotally connected to each other. In the example shown in FIG. 4, the master rod 174 includes a first segment 173 extending from a first rod pivot 176 to a second rod pivot 182, and a second segment 175 extending from the second rod pivot 182 to a third rod pivot 186. The first and second segments 173, 175 may freely pivot relative to each other about the second rod pivot 182.

The unison ring 56 of the first stage 60 is pivotally connected to an output arm 66 of a first bellcrank 68 which is pivotally connected to the compressor case 30 at a first case pivot 70. The pivotal connection of any of the bellcranks to their respective unison rings may be indirect, for example through a link 67 as illustrated which has as first end pivotally connected to the output arm 66 and a second end pivotally connected to the unison ring 56. Such links 67 provide compliance so that the stator vane assemblies 32 and bellcranks can move without binding, even when the output arm 66 is a different length than the lever arms 50. An input arm 72 of the first bellcrank 68 is pivotally connected to the master rod 174 at the first rod pivot 176.

The unison ring 56 of the second stage 62 is pivotally connected to an output arm 66 of a second bellcrank 78 which is pivotally connected to the compressor case 30 at a second case pivot 80. An input arm 72 of the second bellcrank 78 is pivotally connected to the master rod 174 at the second rod pivot 182.

Finally, the unison ring 56 of the third stage 64 is pivotally connected to an output arm 66 of a third bellcrank 84 which is pivotally connected to the compressor case 30 at a third case pivot 86. An input arm 72 of the third bellcrank 84 is pivotally connected to the master rod 174 at the third rod pivot 186.

The segmented master rod 174 is connected to an actuator 88 (shown schematically) which is operable to selectively translate the master rod 174 in a direction labeled “X” as described above. In the illustrated example the master rod 174 is coupled to the actuator 88 by way of a coupler segment 171 which is pivotally connected to the first rod pivot 176.

Translation of the master rod 174 along the X-direction causes rotation of the first, second, and third bellcranks 68, 78, and 84 about their respective case pivots. This in turn causes the output arms 66 to move the respective unison rings 56 in a direction labeled “Y” which is generally perpendicular to direction X.

As described above, the ratio of movement in direction Y to movement in direction X (output ratio) is governed by the relative length of the output arm 66 (labeled Lₒ) to the input arm 72 (labeled Lᵢ). The output ratio may be expressed as Lₒ/Lᵢ. It will be understood that the ends of the output arms 66 do not move in a purely linear fashion, but rather sweep out an arc having a center at the corresponding case pivot. However, the displacement in the Y direction is what is of interest.

Accordingly, if it is desired to vary the Y-direction displacement, this may be carried out by altering the relative lengths of the input arms to the output arms of the bellcranks 68, 78, or 84. This may be done with extra flexibility as compared to prior art configurations because the lengths of either the input arms 72 or the output arms 66 may be changed.

Each variable vane apparatus 32 coupled to the segmented master rod 174 may have a separate, arbitrary output ratio Lₒ/Lᵢ. In the example illustrated in FIG. 4, the first bellcrank 68 has an output ratio Lₒ/Lᵢ of approximately 1:1, the second bellcrank 78 has an output ratio Lₒ/Lᵢ of approximately 0.5:1, and the third bellcrank 84 has an output ratio of approximately 2:1.

The use of the segmented master rod 174 permits a given ratio to be achieved by different combinations of input arm length to output arm length. For example, and output ratio of 0.5:1, starting from a nominal baseline of a 1:1 output ratio, may be achieved by halving the length of the output arm 66, or by doubling the length of the input arm 72.

The use of the segmented master rod 174 permits the implementation of output ratios less than unity which may be highly impracticable or impossible using prior art configurations.

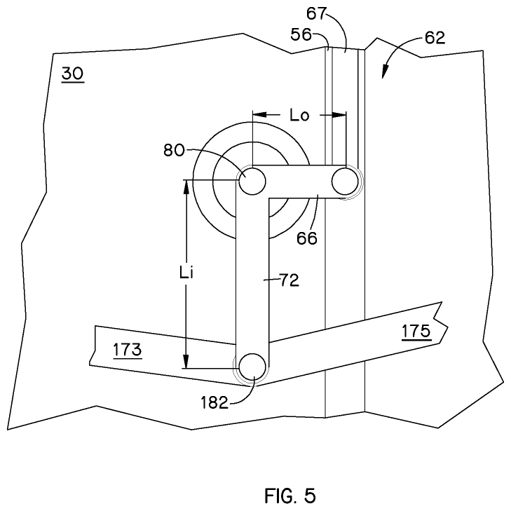

For example, FIG. 5 illustrates the second bellcrank 78 having an output ratio Lₒ/Lᵢ of approximately 0.5 to 1, achieved by increasing the length of the input arm 72 as required while maintaining the length of the output arm 66 at a minimum necessary to avoid binding, interference, or difficulty of assembly.

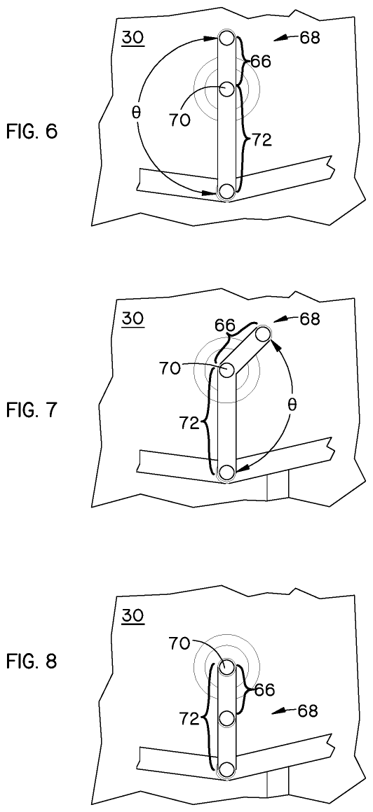

In the examples described above, the input and output arms of the bellcranks are substantially perpendicular to each other (i.e. their included angle is substantially 90 degrees). It is noted that the angular relationship of the arms of the bellcranks may be varied to suit a particular application. Possible examples are shown in FIGS. 6-8. s shows a bellcrank 68 having an output arm 66 in line with the input arm 72 and disposed on the opposite side of the case pivot 70. This may be described as having an included angle θ of 180 degrees. It could also be described as the input arm 72 and the output arm 76 being inline with each other. FIG. 7 shows a bellcrank 68 having an output arm 66 disposed at an oblique angle to the input arm 72. The included angle θ in this example is approximately 135 degrees. FIG. 8 shows a bellcrank 68 having an output arm 66 inline with the input arm 72 and disposed on the same side of the case pivot 70. This may be described as having an included angle of 0 degrees. Regardless of the relative orientation of the arms of the bellcrank, the principles of using a segmented master rod are equally applicable. It is also noted that in describing the bellcrank, the term “arm” does not necessarily require the relatively long, narrow elements shown in the figures as examples. Effectively, any two pivot points in a body separated by a space will effectively define an “arm”. For example, in the embodiments shown in FIGS. 6 and 8, the bellcrank 68 may constitute a single bar- or beam-like element with multiple spaced-apart pivot points. Similarly, functional “arms” may be defined in other arbitrary shapes such as cams, circles, polygons, etc. by providing multiple, space-apart pivot points therein

The apparatus described herein has advantages over the prior art. By breaking the master rod into segments, the bellcrank input length can be adjusted to allow the desired output without using output lengths that are not possible or outside size constraints.

The foregoing has described a variable vane apparatus. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

Further aspects of the invention are provided by the subject matter of the following numbered clauses:

1. A variable vane apparatus, comprising: a case including two or more spaced-apart case pivots; a bellcrank pivotally connected to each case pivot, each of the bellcranks having an input arm and an output arm; a master rod including two or more segments pivotally connected to each other at rod pivots; and wherein the input arm of each of the bellcranks is pivotally connected to one of the rod pivots.

2. The apparatus of any preceding clause wherein each of the bellcranks has an output ratio defined as the length of its output arm divided by the length of its input arm, and the output ratios of two or more of the bellcranks are different from each other.

3. The apparatus of any preceding clause wherein each of the bellcranks has an output ratio defined as the length of its output arm divided by the length of its input arm, and the output ratio of at least one of the bellcranks is less than unity.

4. The apparatus of any preceding clause wherein each of the bellcranks has an output ratio defined as the length of its output arm divided by the length of its input arm, and the output ratio of at least one of the bellcranks is approximately 0.5.

5. The apparatus of any preceding clause wherein: each of the bellcranks has an output ratio defined as the length of its output arm divided by the length of its input arm; the output ratio of at least one of the bellcranks is less than unity; and the output ratio of at least one of the bellcranks is greater than unity.

6. The apparatus of any preceding clause further comprising an actuator connected to the master rod.

7. The apparatus of any preceding clause wherein: the case includes a plurality of variable vane assemblies each including an annular array of vanes pivotally mounted in the case and having a lever arm extending therefrom; each variable vane assembly includes a unison ring surrounding the case and pivotally connected to each of the lever arms of the corresponding variable vane assembly; and the output arm of each of the bellcranks is pivotally connected to one of the unison rings.

8. The apparatus of any preceding clause wherein the input arm and the output arm of at least one of the bellcranks are inline with each other.

9. The apparatus of any preceding clause wherein the input arm and the output arm of at least one of the bellcranks are disposed at an oblique angle to each other.

10. The apparatus of any preceding clause wherein the input arm and the output arm of at least one of the bellcranks are disposed at a 90 degree angle to each other

11. A gas turbine engine, comprising: a turbomachinery core including a compressor, a combustor, and a turbine in serial flow relationship; the core including a case including two or more spaced-apart case pivots; a bellcrank pivotally connected to each case pivot, each of the bellcranks having an input arm and an output arm; a master rod including two or more segments pivotally connected to each other at rod pivots; and wherein the input arm of each of the bellcranks is pivotally connected to one of the rod pivots.

12. The gas turbine engine of any preceding clause wherein each of the bellcranks has an output ratio defined as the length of its output arm divided by the length of its input arm, and the output ratios of two or more of the bellcranks are different from each other.

13. The gas turbine engine of any preceding clause wherein each of the bellcranks has an output ratio defined as the length of its output arm divided by the length of its input arm, and the output ratio of at least one of the bellcranks is less than unity.

14. The gas turbine engine of any preceding clause wherein each of the bellcranks has an output ratio defined as the length of its output arm divided by the length of its input arm, and the output ratio of at least one of the bellcranks is approximately 0.5.

15. The gas turbine engine of any preceding clause wherein: each of the bellcranks has an output ratio defined as the length of its output arm divided by the length of its input arm; the output ratio of at least one of the bellcranks is less than unity; and the output ratio of at least one of the bellcranks is greater than unity.

16. The gas turbine engine of any preceding clause further comprising an actuator connected to the master rod.

17. The gas turbine engine of any preceding clause wherein: the case includes a plurality of variable vane assemblies each including an annular array of vanes pivotally mounted in the case and having a lever arm extending therefrom; each variable vane assembly includes a unison ring surrounding the case and pivotally connected to each of the lever arms of the corresponding variable vane assembly; and the output arm of each of the bellcranks is pivotally connected to one of the unison rings.

18. The gas turbine engine of any preceding clause wherein the input arm and the output arm of at least one of the bellcranks are inline with each other.

19. The gas turbine engine of any preceding clause wherein the input arm and the output arm of at least one of the bellcranks are disposed at an oblique angle to each other.

20. The gas turbine engine of any preceding clause wherein the input arm and the output arm of at least one of the bellcranks are disposed at a 90 degree angle to each other.

What is claimed is:

1. A variable vane apparatus, comprising:
a case including two or more spaced-apart case pivots;
a bellcrank pivotally connected to each case pivot, each of the bellcranks having an input arm and an output arm;
a master rod including two or more segments pivotally connected to each other at rod pivots; and
wherein the input arm of each of the bellcranks is pivotally connected to one of the rod pivots.

2. The apparatus of claim 1 wherein each of the bellcranks has an output ratio defined as the length of its output arm divided by the length of its input arm, and the output ratios of two or more of the bellcranks are different from each other.

3. The apparatus of claim 1 wherein each of the bellcranks has an output ratio defined as the length of its output arm divided by the length of its input arm, and the output ratio of at least one of the bellcranks is less than unity.

4. The apparatus of claim 1 wherein each of the bellcranks has an output ratio defined as the length of its output arm divided by the length of its input arm, and the output ratio of at least one of the bellcranks is approximately 0.5.

5. The apparatus of claim 1 wherein:
each of the bellcranks has an output ratio defined as the length of its output arm divided by the length of its input arm;
the output ratio of at least one of the bellcranks is less than unity; and
the output ratio of at least one of the bellcranks is greater than unity.

6. The apparatus of claim 1 further comprising an actuator connected to the master rod.

7. The apparatus of claim 1 wherein:
the case includes a plurality of variable vane assemblies each including an annular array of vanes pivotally mounted in the case and having a lever arm extending therefrom;
each variable vane assembly includes a unison ring surrounding the case and pivotally connected to each of the lever arms of the corresponding variable vane assembly; and
the output arm of each of the bellcranks is pivotally connected to one of the unison rings.

8. The apparatus of claim 1 wherein the input arm and the output arm of at least one of the bellcranks are inline with each other.

9. The apparatus of claim 1 wherein the input arm and the output arm of at least one of the bellcranks are disposed at an oblique angle to each other.

10. The apparatus of claim 1 wherein the input arm and the output arm of at least one of the bellcranks are disposed at a 90 degree angle to each other

11. A gas turbine engine, comprising:
a turbomachinery core including a compressor, a combustor, and a turbine in serial flow relationship;
the core including a case including two or more spaced-apart case pivots;
a bellcrank pivotally connected to each case pivot, each of the bellcranks having an input arm and an output arm;
a master rod including two or more segments pivotally connected to each other at rod pivots; and
wherein the input arm of each of the bellcranks is pivotally connected to one of the rod pivots.

12. The gas turbine engine of claim 11 wherein each of the bellcranks has an output ratio defined as the length of its output arm divided by the length of its input arm, and the output ratios of two or more of the bellcranks are different from each other.

13. The gas turbine engine of claim 11 wherein each of the bellcranks has an output ratio defined as the length of its output arm divided by the length of its input arm, and the output ratio of at least one of the bellcranks is less than unity.

14. The gas turbine engine of claim 11 wherein each of the bellcranks has an output ratio defined as the length of its output arm divided by the length of its input arm, and the output ratio of at least one of the bellcranks is approximately 0.5.

15. The gas turbine engine of claim 11 wherein:
each of the bellcranks has an output ratio defined as the length of its output arm divided by the length of its input arm;
the output ratio of at least one of the bellcranks is less than unity; and
the output ratio of at least one of the bellcranks is greater than unity.

16. The gas turbine engine of claim 11 further comprising an actuator connected to the master rod.

17. The gas turbine engine of claim 11 wherein:
the case includes a plurality of variable vane assemblies each including an annular array of vanes pivotally mounted in the case and having a lever arm extending therefrom;
each variable vane assembly includes a unison ring surrounding the case and pivotally connected to each of the lever arms of the corresponding variable vane assembly; and
the output arm of each of the bellcranks is pivotally connected to one of the unison rings.

18. The gas turbine engine of claim 11 wherein the input arm and the output arm of at least one of the bellcranks are inline with each other.

19. The gas turbine engine of claim 11 wherein the input arm and the output arm of at least one of the bellcranks are disposed at an oblique angle to each other.

20. The gas turbine engine of claim 11 wherein the input arm and the output arm of at least one of the bellcranks are disposed at a 90 degree angle to each other.
